(19) United States
(12) Patent Application Publication
(10) Pub. No.: US 2012/0211556 A1
(43) Pub. Date: Aug. 23, 2012

(54) Arrangement for Recognizing Bar-code Information

(75) Inventor: Hans Heckenberger, Assmanshardt (DE)

(73) Assignee: Kaltenbach & Voigt GmbH, Biberach (DE)

(21) Appl. No.: 13/400,003

(22) Filed: Feb. 17, 2012

(30) Foreign Application Priority Data
Feb. 22, 2011 (DE) DE102011004497.3

(51) Int. Cl. G06K 7/10; G06F 17/30

(52) U.S. Cl. 235/375; 235/462.1; 235/462.03; 235/462.2

(57) ABSTRACT

An arrangement for recognizing bar-coded information on a carrier object, with registration means designed to register bar-coded information in a registration zone, the arrangement exhibiting adaptation means designed to change the registration zone, an arrangement for recognizing bar-coded information on a spray can, a process for recognizing information on a spray can, a medical maintenance appliance, and a process for maintaining medical appliances.

### BACKGROUND OF THE INVENTION

1. Field of the Invention

The present invention relates to an arrangement for recognizing bar-coded information on a carrier object. An arrangement of such a type may come into operation, in particular, in an appliance for maintaining and/or disinfecting medical instruments, in particular dental instruments, in order to identify cleansing agents or treatment agents to be used by this appliance.

2. Related Technology

Dental instruments require maintenance from time to time for the purpose of preserving their function, particularly in the case of drive elements that are rotatably mounted. Furthermore, the ever more stringent hygiene requirements in dental practice have the consequence that a conditioning of dental instruments has to be undertaken at regular time-intervals. In this connection the successful conditioning and observance of the appropriate specifications must be continuously documented by the dentist, entailing a not inconsiderable effort in terms of staff and organization.

In the meantime, however, cleansing appliances and disinfecting appliances have appeared on the market, in which the instruments are conditioned before they are subjected to oiling, for example. Mechanical conditioning affords distinct advantages in comparison with a manual maintenance of the instruments, since only a mechanical process enables a reliable and reproducible cleansing and maintenance. In each case the maintenance procedure and, in particular, the treatment agent have to be adapted to the dental instrument to be maintained.

With the aid of bar codes it is possible to undertake diverse markings. The evaluation of these markings opens up the possibility of executing assigned sequences on the basis of the marking, for example the registering of a certain amount onto a total bill at the supermarket checkout or the logging of a time-value when an assigned marking is recognized.

Usually the bar-coded information has been applied in compact form on the carrier object to be marked. In many cases, areas dedicated thereto are provided on the carrier object. However, the evaluation of the marking turns out to be particularly difficult if the surfaces of the carrier objects to be marked do not principally exhibit flat areas. In particular, this difficulty frequently obtains also in the case of containers for treatment agents for maintaining medical instruments, in particular dental instruments.

Readers for bar codes according to the state of the art evaluate the optical response of an illuminated item of bar-coded information. For this purpose a signal-registration unit has to register and assess the illumination response of the bar-coded information in a registration zone.

A common device provides for directing an excitation signal, in particular a laser signal, over a region of the bar-coded information at predetermined frequency in such a way that a registration zone from which the bar-coded information is read is totally covered by the optical excitation signal. The evaluation of the optical response then takes place in a manner synchronous with the excitation, so that after evaluation of the synchronism information in conjunction with the optical response an assessment of the bar-coded information can be made.

In addition, image-evaluating systems are also known that analyze an item of optical response information, ascertained for example with the aid of a CCD sensor (charge-coupled device) in a certain registration zone, and in this way register the bar-coded information arranged in the registration zone on the carrier object. A temporally sequenced excitation signal is not necessary in this case for the purpose of assessing the bar-coded information, since a registration of the total information in the registration zone is possible directly with the aid of the CCD sensor. Consequently, in contrast with an excitation with a laser, the excitation can be effected, for example, in locally barely restricted manner with the aid of one or more LEDs which illuminate the entire registration zone.

With all these systems, in the case of surfaces that are shaped in a complex manner—such as are determined, for example, by cylindrically shaped containers for treatment agents—it may happen that signal errors are caused to an increased extent by reason of the distorted optical response of surfaces of such a type, because, for example, spacings or line widths in a complex arrangement can only be determined with difficulty, or generally an assessment of shapes is not possible.

### SUMMARY OF THE INVENTION

Accordingly, the invention is intended to improve the possibilities for recognizing bar-coded information on a carrier object, in particular having a complex shape, preferably on a container for treatment agent for maintaining medical or dental instruments, and at the same time to specify an inexpensive solution.

In accordance with the invention, an arrangement is provided for recognizing bar-coded information on a carrier object, with registration means designed to register bar-coded information in a registration zone. In addition, the arrangement includes adaptation means designed to change the registration zone.

For the purpose of registering an item of bar-coded information it is necessary to assess or evaluate a coherent item of information and, for example, to recognize start or stop symbols of a bar code. Therefore, the registration zone according to the invention exhibits at least the extent of an assessable item of bar-coded information and, in accordance with the invention, there is provision to change the registration zone.

This involves, for example, the possibility of being able to adapt the registration zone to the surface properties of the carrier object, preferably to a container for treatment agent for maintaining medical instruments. For example, the registration zone may have been changed in its location, but also in its shape.

In a further development of the inventive idea the change of the registration zone may, for example, be realized by the adaptation means being designed to vary the spatial arrangement of the registration means. For example, the distance in relation to the carrier object may be altered, the solid angle of the orientation in relation to the carrier object may be modified, or generally the location of the registration means may be varied. In addition, it is likewise possible that this has been realized in a multiplicity of individual registration means.

It is particularly advantageous if the registration means has been designed to register several elements of an item of bar-coded information simultaneously. For example, in this connection it may be a question of several assessable regions of a bar code. In particular, it is possible to improve the detection of errors. In this way it is possible, for example, for redundancy information to be obtained that can be evaluated for the purpose of error correction.

A further development of the inventive idea, which likewise supports the redundancy concept, may, for example, have been realized by the registration zones at least partially overlapping before and after the change with the aid of the adaptation means.

In a preferred further development of the invention the adaptation means is designed to rotate or swivel the registration means within an angular range α. The swivel motion preferably follows, at least in sections, the surface shape of the carrier object, preferably the surface shape of a container for treatment agent for maintaining medical or dental instruments. However, the invention is not restricted thereto. For example, for the purpose of lowering a read-error rate it may be useful if the arrangement for recognizing an item of bar-coded information has been designed to change the spacing of the registration means from the surface of the carrier object, for example a container for treatment agent. Particularly in the case of complex surface shapes of the carrier object, which possibly exhibit projections, by this method it is advantageous to resolve or to assess optically the distortion-burdened bar-coded information at a different angle.

In one embodiment, the adaptation means includes a servomotor that has been designed to move the registration means. For example, in the construction of models it is conventional to execute control requirements with the aid of positioning motors—so-called servomotors—which are available as prefabricated assemblies or as a combination of electric motor and associated transmission, so that precise movements can be executed with high regulating power.

In a particularly preferred manner, the registration means includes a bar-code scanner which, in particular, preferably exhibits a charge-coupled device (CCD) read unit. Assigned to the latter is, for example, a registration zone which is established by the CCD optics. The bar-code scanner or the registration means is or are preferably arranged in an independent housing. However, the invention is by no means restricted to the use of CCD-based bar-code scanners. For example, in one embodiment of the invention it is just as conceivable to provide laser scanners, also in omnidirectional form, or registration means of a different nature with a registration zone which includes an assessable item of bar-coded information on a carrier object.

In a further embodiment of the invention, the arrangement for recognizing an item of bar-coded information is designed to register and evaluate two-dimensionally bar-coded information. This is preferably realized by an item of one-dimensionally bar-coded information firstly being read or registered by the registration means and by the adaptation means being designed to change the registration zone in such a way that an item of two-dimensionally bar-coded information can be combined from several items of one-dimensionally bar-coded information.

A container for a treatment agent for maintaining dental or medical instruments can be realized, for example, by a spray can according to the invention.

A further aspect of the invention therefore relates to an arrangement for recognizing information on a container for a treatment agent for maintaining dental or medical instruments, in particular on a spray can, with a container for a treatment agent for maintaining dental or medical instruments, preferably with a spray can, and with an arrangement according to the invention for recognizing bar-coded information. The surface of the container, in particular of the spray can, may in this case exhibit areas that are substantially not flat. For example, this is the case in the region of the circumferential surface of the spray can, so that a recognition there of bar-coded information may be particularly erroneous by reason of possible distortions.

The bar-coded information arranged on the spray can is preferably at least partially an arrangement of concentric rings; in a particularly preferred embodiment, the common center of the rings is identical with the midpoint of the cross-section of the spray can.

In one embodiment of the invention the bar-coded information arranged on the container or on the spray can is an item of two-dimensionally bar-coded information, or exhibits regions that enable a redundant evaluation of information. A registration of the item of two-dimensionally bar-coded information can then be effected by a process described above; the advantageous registration of redundancy information is explained in a process described below.

A further aspect of the invention relates to a process for recognizing information on a container for a treatment agent for maintaining dental or medical instruments, in particular on a spray can with an arrangement according to the invention for recognizing information on a container for treatment agent for maintaining dental or medical instruments, the process comprising the following steps:
a) recognizing an item of bar-coded information in a registration zone arranged on the container, preferably on the spray can, and assessing the validity of the information;
b) changing the registration zone on the container, in particular on the spray can, if no valid information was recognized in step a); and,
c) repeating steps a) and b) for such time until a valid item of information is recognized or no further change of the registration zone is possible.

In a further embodiment of the process the change of the registration zone on the container, preferably on the spray can, is effected by rotating the registration means.

As indicated above, the aspect of an unambiguous registration of bar-coded information for medical applications is particularly important to avert disadvantages for patients. Consequently the inventive process can be employed advantageously, in particular, in medical engineering. This will become clear, for example, through the device described in the following.

A further aspect of the invention relates to a medical maintenance appliance for maintaining medical appliances, in particular dental appliances, with an arrangement, according to the invention, for recognizing information on a container for treatment agent for maintaining dental or medical instruments, in particular on a spray can. In this connection an item of information read out by the arrangement for recognizing an item of bar-coded information preferably is an item of control information for implementing a maintenance procedure for medical appliances, in particular dental appliances.

Consequently, through the improvement of the registration of information with an arrangement according to the invention for registering bar-coded information a substantial contribution to the improvement of the maintenance of medical appliances and hence to the improvement of the medical treatment is achieved. In particular in this connection, errors in the hygienic conditioning of medical instruments can be avoided. For example, the process described in the following also contributes to this.

A further aspect of the invention relates to a process for maintaining medical appliances or instruments, with a medical maintenance appliance according to the invention, wherein the bar-coded information identifies a treatment agent for medical, in particular dental, appliances or instruments and an assigned maintenance sequence for medical or dental appliances or instruments is selected on the basis of the identified treatment agent.

### BRIEF DESCRIPTION OF THE DRAWINGS

The invention is described below with reference to the drawings, wherein identical elements in all the representations have been provided with the same reference symbols. Shown are:

FIG. 1 an embodiment of an arrangement according to the invention for recognizing bar-coded information on a carrier object;

FIG. 2 examples of a change of a registration zone of registration means for bar codes;

FIG. 3 the combination of a bar-code scanner with a servomotor;

FIG. 4 an embodiment of an arrangement according to the invention for recognizing bar-coded information on a spray can; and

FIG. 5 a preferred arrangement of bar codes on a cylindrical carrier object.

### DETAILED DESCRIPTION

It is a particular challenge to recognize an item of bar-coded information 200 reliably on surfaces that are shaped in a complex manner—such as, for example, on a container for treatment agent for maintaining medical or dental instruments—and that exhibit, for example, curves or projections. In particular, under these circumstances it proves difficult to evaluate spacings and line thicknesses in order to reproduce the coded information 200 correctly. Particularly in the case of medical applications, an item of information recognized incorrectly may then result in severe disadvantages for the patient; this may, for example, relate to the hygienic conditioning of dental appliances or instruments.

The invention specifies a cost-optimized solution for an improved read-out rate of bar-coded information 200, particularly on surfaces of the type described above.

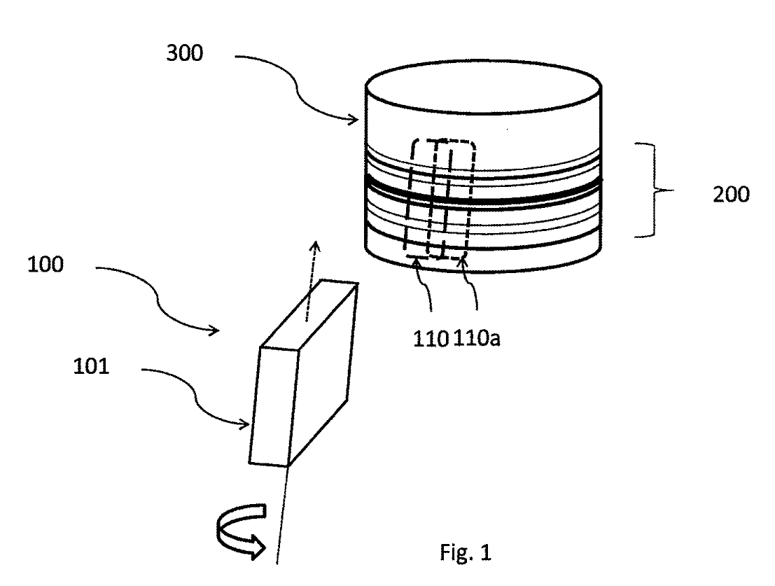

As shown in FIG. 1, registration means 100 for bar-coded information 200 are provided, preferably in an independent housing 101, in the arrangement for recognizing an item of bar-coded information 200.

For example, registration means 100 may enter into consideration that exhibit a registration zone 110 that has at least the extent in order to be able to assess an item of bar-coded information. In the case of the registration means 100 it preferably is a question of known bar-code readers that recognize a standardized bar code as an item of coherent information, preferably one or more of the codes EAN, UPC, IAN, JAN, Zielkode, code of the 2/5 family, Code 39, Code 93, Code 128 or Codebar. Moreover, in accordance with the invention, it is possible that the bar-coded information exhibits, at least partially, regions that carry a coding in a further development of bar codes—that is to say, for example, regions that code information by means of rhombic, punctiform or square structures.

FIG. 1 shows registration means 100 in the form of a CCD bar-code reader, with a registration zone 110 that overlaps in partial regions with an item of bar-coded information 200. The item of bar-coded information 200 is totally present in this case as an item of bar-coded information in the registration zone 110 at least in one dimension and can accordingly be registered coherently and completely by the registration means 100 in this dimension, so that an assessment of the information is possible. With respect to the assessability of an item of bar-coded information it is preferably assumed that the bar-coded information comprises at least two elements that are different from one another, and in this way the registration zone exhibits, for example, two elements of the item of bar-coded information 200 that are different from one another.

In a further development, the registration means 100 is designed to make information available about several elements of the item of bar-coded information 200 arranged in the registration zone 110 in the course of an information-exchange procedure with evaluating means. This also enables the success of the procedure for reading one or more items of bar-coded information to be appraised or assessed immediately.

For example, there may be provision that the arrangement for recognizing bar-coded information 200 on a carrier object 300 exhibits an evaluating means that has been designed to appraise one or more elements of an item of the bar-coded information 200.

According to the invention, the registration zone 110 of the registration means 100 is varied in the case of insufficient recognition of the information 200. For this purpose, the arrangement, which is preferably integrated into a medical maintenance appliance, exhibits an adaptation means designed to change the registration zone 110.

In this connection it preferably is a question of a local change of the registration zone 110, but the shape of the registration zone 110 or even the extent of the area thereof can also be influenced by the adaptation means. Particularly in the case of surfaces that are shaped in a complex manner, a spatial change of the registration means 100 in relation to the carrier object 300 of the bar-coded information 200 gives rise to a simultaneous modification of all these parameters of the registration zone 110. However, the change of the registration zone 110 may also relate to altered reflective properties such as, for example, the direction of reflection or the reflective intensity of the surface of the carrier object, in particular of a container for treatment agent for maintaining dental or medical instruments in the registration zone 110.

Assigned to the registration means 100 in this connection is a zone with a registration-zone shape that is characteristic of the respective type of the registration means 100—for example, a rectangle, an ellipse or a bar—from which the bar-coded information 200 is to be determined. In this connection the projection of this registration-zone shape onto the surface of the carrier object 300 determines the optical response of the surface of the carrier object, therefore the registered item of bar-coded information 200, and also the shape and area of the registration zone 110.

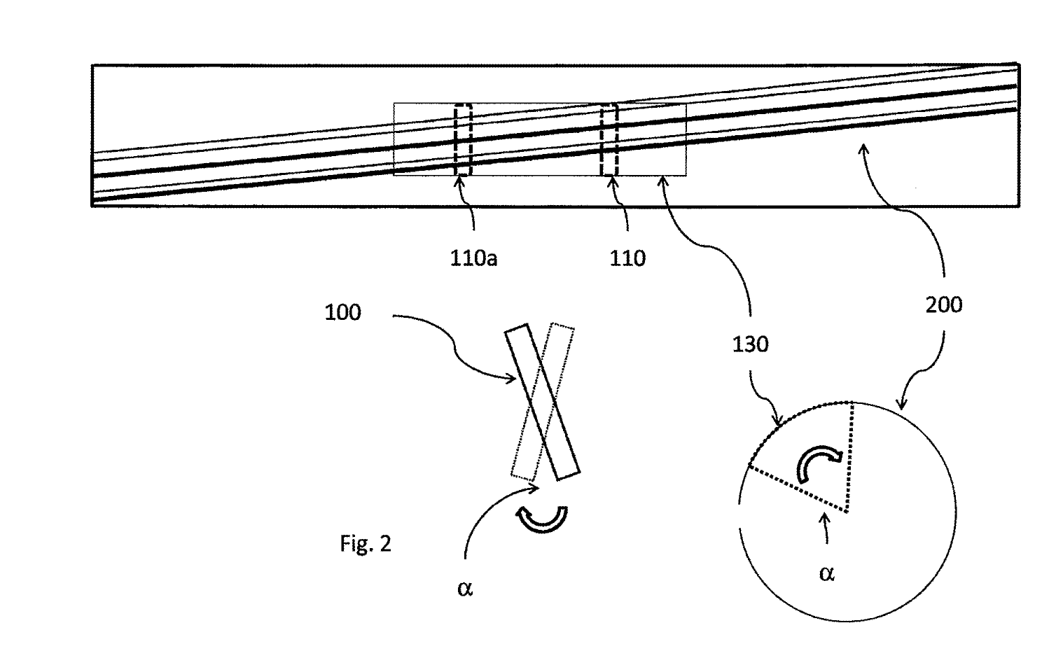

In the case of a cylindrically shaped carrier object 300 such as is represented in FIG. 2, for example for a container for treatment agent, a rotation of the registration means 100 about an angle α denotes the change of the registration zone 110 to a registration zone 110a, the latter being in this embodiment locally separated from the registration zone 110. However, it is also possible that the registration zone 110 assigned to the arrangement prior to the start of the change overlaps locally with the registration zone 110a after the change. With rotation of the registration means 100 about an angle α, the projection of the characteristic registration-zone shape onto the surface of the carrier object 300 or of the container is also altered, so that both the local position and the size of the registration zone 110a after the change may differ in relation to the registration zone 110 prior to the start of the change.

The size of the aforementioned registration zone 110a in relation to the registration zone 110 preferably has been increased.

It is an advantage that the registration means 100 has been designed to change, in this example by virtue of the rotation about small angles α, the distance between surface of the carrier object 300 or of the container for treatment agent and the registration means 100.

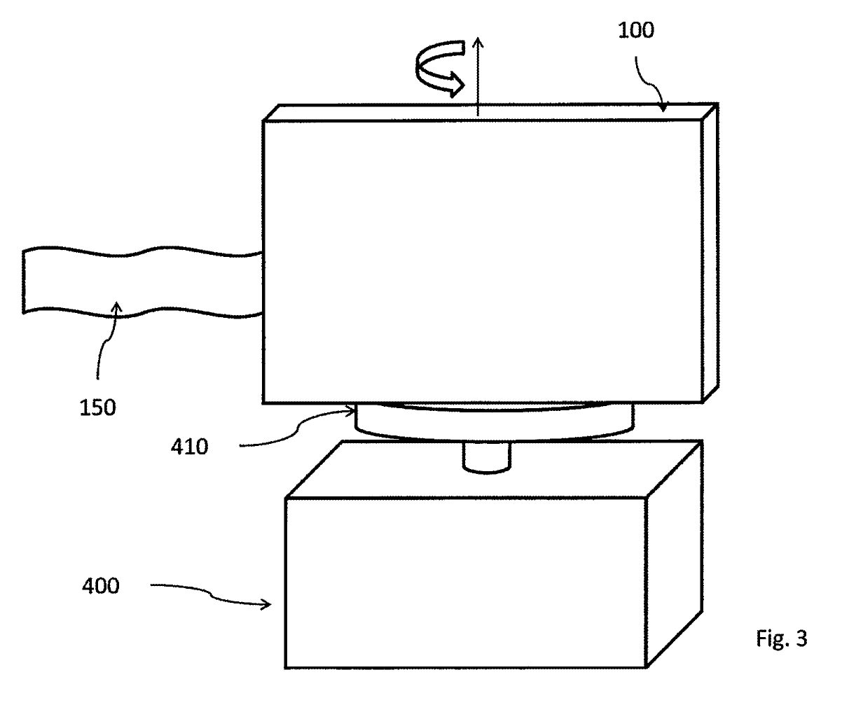

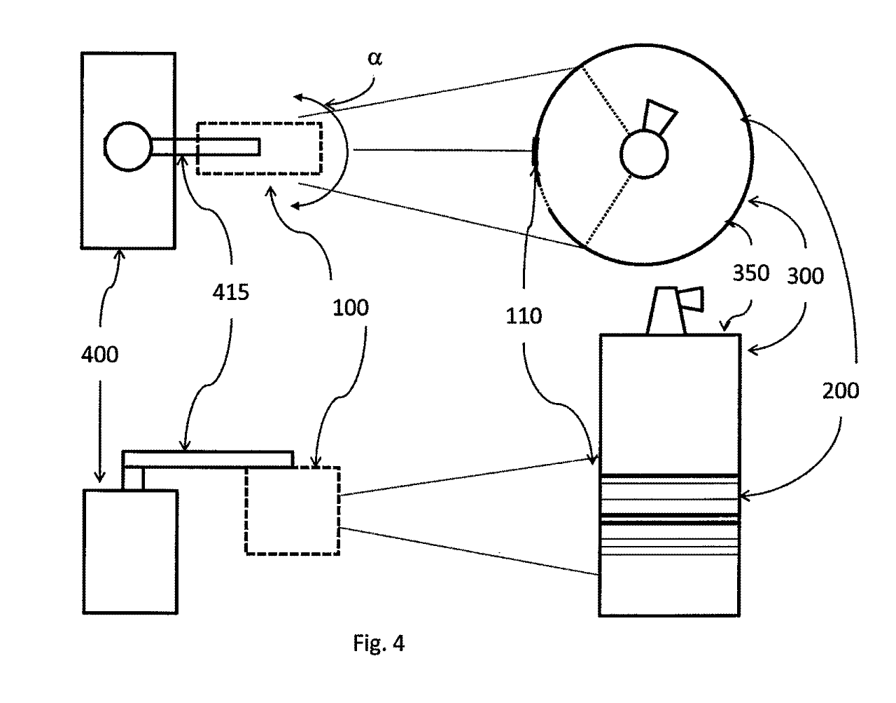

In a further development of the inventive idea represented in FIGS. 3 and 4, the arrangement for recognizing the bar-coded information 200 on a carrier object 300 exhibits a servomotor 400 which, for example, makes available a combination of electric motor and transmission in an independent housing. In particular in this connection it may be a question of a servomotor 400 which, for example, finds application in the construction of electrically controlled functional models. This combines the possibility of an inexpensive provision of a motor/transmission combination with a precise design for predetermined courses of motion of the registration means 100; for example, in this way the construction of independent transmissions can be avoided. A further advantage of these motors is that servomotors of the stated type preferably have been designed to operate within a limited angular range, that accordingly running-intervals between a start position and a stop position have been predetermined; for example, in addition a position or angle of rotation within the running-interval is capable of being set by a value of a control voltage that has been provided for the purpose of control.

Alternatively, there could also be provision to use a stepping motor.

In addition, in the construction of models various fastening means or articulation means for control functions are conventional, which can easily be integrated into adaptation means of the arrangement according to the invention. For example, in the case of these means it may be a question of a swash plate 410, an articulation rod 415, or a connecting rod, which have been designed to be capable of being connected to the registration means 100 or to a plug-in module or holder for the registration means 100. Of course, these means may also have been connected to the servomotor 400 or to an appropriate stepping motor.

The change, provided in accordance with the invention, of the registration zone 110 affords diverse advantages which drastically increase the registration rate for bar-coded information 200.

For example, the change of the registration zone 110 to a registration zone 110a offers the possibility of circumventing errors or deficits of the bar-coded information 200 contained in the registration zone 110 with the aid of redundant bar-code information 200 in the zone 110a, in order to form an error-free item of overall information. This is preferably assisted by options for arrangement of the bar-coded information 200 which are described in the following.

In addition, just a slight change of the registration zone 110 to a registration zone 110a, which is accompanied, for example, by substantially overlapping registration zones 110 and 110a, can optimize the recognition of information, since reflective properties of the carrier surface can be utilized in a changed manner for the purpose of gathering information. In this connection, the expression ‘substantially overlapping registration zones 110, 110a’ is to be interpreted in such a way that the registration zones 110 and 110a can be converted into one another by a transformation of a marginal-line portion of dimensions less than four fifths of the marginal line of registration zone 110.

In a preferred embodiment, the adaptation means merely modify the orientation of the registration means 100 in relation to the registration zone 110, so that principally reflective properties of the registration zone 110 are changed. In many cases this already gives rise to an improvement of the recognition of the bar-coded information 200.

With the aid of the change of the registration zone 110 a possibility is furthermore created to read out two-dimensionally bar-coded information. The arrangement for recognizing bar-coded information is then preferably designed to register or to assess two-dimensionally bar-coded information. For example, the redundant information for error correction can be given in a two-dimensionally coded form, so that the arrangement may have evaluating means available that are designed for the purpose of error correction with the aid of an item of two-dimensionally coded information.

In particular, there may be provision that the registration means 100 is designed to register an item of one-dimensionally bar-coded information, and the arrangement for registering bar-coded information is designed to complete the registration of the two-dimensionally bar-coded information 200 by changing the registration zone 110 to a registration zone 110a. In particular for this purpose, a multiple change of the registration zone 110 may also be provided.

FIG. 4 shows an arrangement for recognizing information on a spray can 350 with an arrangement according to the invention for recognizing bar-coded information on a carrier object 300, such as can be incorporated into a dental maintenance appliance, for example. The spray can 350 stores one or more treatment agents for maintaining dental or medical instruments. The bar-coded information 200 preferably exhibits an optimized arrangement with redundancy regions.

In particular, a redundancy region may also have been established by virtue of the fact that the bar-coded information 200 exhibits a spatial extent that is substantially larger than the area of the registration zone 110. ‘Substantially’ in this connection means that the spatial extent is, for example, twice as large as the registration zone 110, preferably 100 times as large, particularly preferably 1000 times as large.

Especially in the case of complex shapes—such as, for example, of the spray can 350—there may be provision that the arrangement of the bars of the bar-coded information 200 exhibits at least two spatially separated regions which, preferably illuminated from different angles, reproduce an identical item of information. In particular, it is conceivable that bar patterns of the bar-coded information of the two regions are disjoint and, in addition, represent, for example, an item of two-dimensionally bar-coded information, but also that the bar patterns have been coherently structured.

In a further development of the inventive idea, the bar patterns of the bar-coded information 200 have been adapted to the surface shape of the carrier object 300, preferably to the surface shape of the container for treatment agent for maintaining medical or dental instruments. For example, there may be provision that the arrangement of the bars takes distortions into account that are to be expected in the course of a read-out procedure by reason of the surface shape, with an optical registration of the information at a certain angle. For example, these are shapes of the field curvature or astigmatic distortions.

For the case of the embodiment represented in FIG. 4, with rounded shapes, this may mean, for example, that bars or elements of an item of bar-coded information 200 are oriented along a curve. It proves particularly advantageous if, corresponding to the embodiment shown, in the case of cylindrical shapes of the carrier object 300 the bar patterns of the bar-coded information 200 follow the circular or approximately ellipsoidal cross-section of the cylinder and, particularly preferably, the bars take the form of substantially concentric circles. ‘Substantially’ in this case means that at least half of the circular line, preferably at least two thirds, particularly preferably at least eleven twelfths, carries an item of bar-coded information.

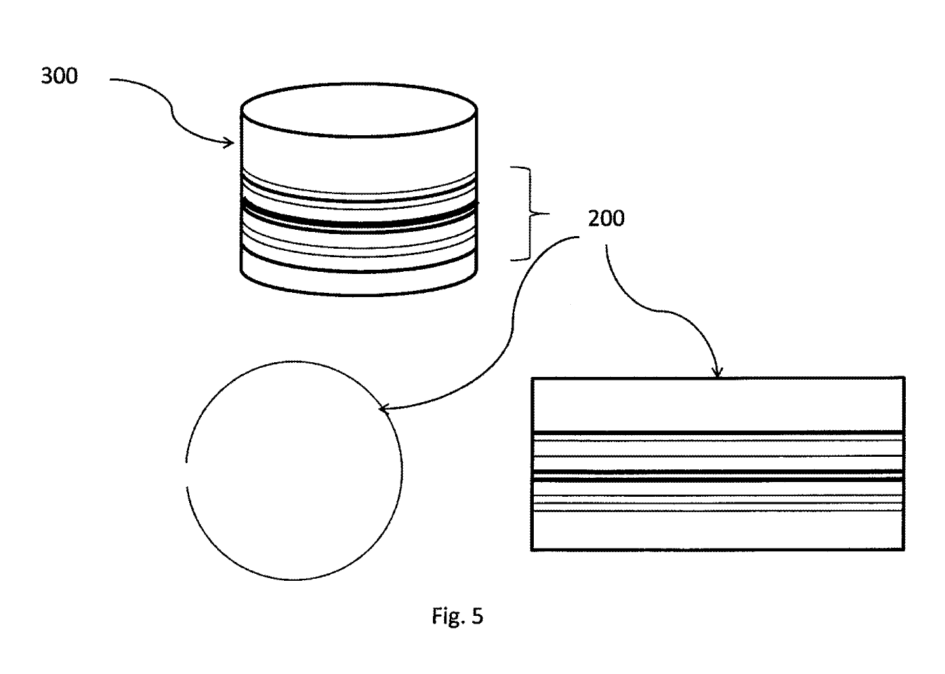

In the embodiment represented in FIG. 4, which shows a spray can 350 by way of carrier object 300, the bar-coded information 200 has been directly printed onto the circumferential surface of the spray can 350. The bar patterns of the item of bar-coded information 200 are in this case constructed as concentric circles and follow the periphery of the circumferential surface. Typically, spray cans 350 exhibit in the region of the circumferential surface a seam which represents a joint of the casing of the spray can. In the embodiment represented, the spray can 350 has been imprinted almost completely with the bar-coded information 200 in the direction of the periphery, whereby merely the seam of the joint exhibits no imprinting; a corresponding detail view is shown in FIG. 5.

In particular, in this embodiment it becomes clear that with the aid of the adaptation means a change of the registration zone 110 is possible in such a manner that a non-imprinted region—that is to say, a region of the bar-coded information 200 that does not contribute to the recognition of information—can be skipped in such a way that an item of redundancy information is sought or ascertained.

In addition, within the scope of a further development there may also be provision that the bar-coded information 200 has been applied on the surface of the carrier object 300 with the aid of a sticker. For example, in this way the region of the seam of a spray can may also be provided with an item of bar-coded information, so that an arrangement of the bar-coded information 200 in completely closed concentric circles is possible and the reliable identification of a container for treatment agent is ensured.

In a preferred embodiment the bar-coded information 200, arranged in concentric circles, is present in such a way that a first, preferably lower, part of the concentric circles represents an item of bar-coded information 200, whereas a second, preferably upper, part of the concentric circles represents an identical item of information and in this way makes redundant information available.

Further supporting the idea of the utilization of redundancy information, in a further development of the inventive idea a process for recognizing bar-coded information 200 on a spray can 350 may comprise the following steps.

To begin with, in a first step, the recognition of an item of bar-coded information 200 in a registration zone 110 arranged on a spray can 350 and also the assessment of the validity of the information are provided; in a further step, for the case where no valid information has been recognized the registration zone 110 on the spray can 350 is to be changed; finally, in a following step there is provision to repeat the aforementioned steps until such time as an item of valid information is recognized or no further change of the registration zone 110 is possible.

In a further development of the process for recognizing bar-coded information on a spray can 350 the change of the registration zone 110 can be effected by rotating or swiveling the registration means 100.

Details of FIGS. 1, 2, and 4 clarify this process. Registration means 100 arranged on an articulation rod 415, in this case a bar-code scanner with a CCD read unit, are capable of being swiveled about an angle α with the aid of a servomotor 400. The registration zone 110 of the bar-code scanner is arranged on a carrier object 300, represented by a spray can 350 by way of a container for a treatment agent, in such a way that an item of one-dimensionally bar-coded information 200 can be registered completely. For the case where this information cannot be assessed or no valid information is registered, there is provision to change the registration zone 110, by rotating about an angle α, to a registration zone 110a. The bar-coded information 200 is in this case arranged in the form of concentric circles almost completely covering the periphery of the spray can, in a lower region of the spray can 350. The angular motion is preferably effected in a continuum direction of the bar-coded information—that is to say, in a direction in which the items of bar-coded information, in particular bars, are continued coherently. In the embodiment described, this is a horizontal swivel motion and, as is immediately apparent, a redundant item of information can thereby be registered in a registration zone 110a. Merely for the case where the information of the registration zone 110a that has now been registered is likewise not valid, a further swivel motion is provided which selects a registration zone differing from the two previously evaluated registration zones 110 and 110a. This can be repeated until such time as a valid item of information is registered or no further change of the registration zone 110 is possible.

In the embodiment shown, by virtue of the swivel motion several registration zones 110 and 110a can be selected in a succession one after the other which cover almost a quarter of the periphery of the spray can. In a further development, in addition there may be provision that in a linear motion, for example for the purpose of adapting to various diameters of spray cans 350, the minimal spacing of the registration means 100 in relation to the carrier object 300 is adaptable. This may have been realized, for example, by a linear motion of an appropriately configured articulation rod 415; in addition, the combination of servomotor 400 and registration means 100, for example, can also be moved linearly as a coherent component.

Following further the embodiment that is illustrated, it proves particularly advantageous if in the case of the carrier object 300 for the bar-coded information 200 it is a question of a spray can 350 for treatment agent for maintaining medical appliances, in particular dental appliances, since this results in a simplified configuration of the maintenance appliance, particularly of the supply of treatment agent.

An assigned maintenance appliance has then preferably been designed to obtain, with the aid of an arrangement according to the invention for recognizing an item of bar-coded information 200, an item of control information for implementing a maintenance procedure for medical appliances, in particular dental appliances.

In particular, there may be provision that the maintenance appliance has been designed to implement a comparison between the control information identified by the bar-coded information with a medical or dental instrument to be maintained, which has preferably been identified by the maintenance appliance. In the case of an item of control information that is inappropriate for the medical instrument, the maintenance appliance could be designed to give an appropriate indication, for example visually or acoustically.

In a further development of the inventive idea, in a process for maintaining medical appliances with the aid of a maintenance appliance that exhibits an arrangement according to the invention for recognizing information on a spray can 50, there is provision that the bar-coded information 200 characterizes a treatment agent for medical appliances, and an assigned maintenance sequence is selected on the basis of the identified treatment agent.

Water and cleansing agents, preferably with surfactants or phosphates, particularly preferably cleansing agents that exhibit a pH value above 10, enter into consideration by way of treatment agent, as well as clear rinsing agents or neutralizers with a pH value from 3 to 5, in particular in the form of phosphoric acid ester. In addition, oils may also have been provided for the purpose of maintenance which, for example, have been designed to be foamed with the aid of blowing agent. An appropriate blowing agent is preferably likewise contained in the container for treatment agent.

The maintenance appliance has preferably been designed to examine, with the aid of the bar-coded information, the correct arrangement of one or more containers for treatment agents for maintaining medical or dental instruments. In this connection there may be provision that the maintenance appliance firstly identifies a medical instrument which preselects a certain maintenance sequence. Subsequently, with the aid of the bar-coded information pertaining to the treatment agents a corresponding maintenance sequence can be confirmed and selected, so that the preselected maintenance sequence starts. Should the maintenance procedure preselected by a medical appliance not correspond to the maintenance procedure that is established by the identified treatment agents, an appropriate indication can be given to the user. The maintenance appliance is preferably designed to disable the maintenance procedure in this case. A faulty operation of the maintenance appliance is consequently prevented effectively.

Lastly, by virtue of the present invention an arrangement for recognizing bar-coded information and a corresponding process are created that permit a substantial improvement of the error-rate in the course of the recognition of an item of bar-coded information. In medical applications in particular, this is of the greatest importance, as is made clear, for example, by an appropriate maintenance appliance for medical appliances and by a process for the application thereof.

In conclusion, in accordance with the invention the combination of features of various embodiments or of features disclosed in drawing figures is not excluded.

1. Arrangement for recognizing bar-coded information on a carrier object, comprising registration means designed to register bar-coded information in a registration zone, and adaptation means designed to change the registration zone.

2. Arrangement for recognizing bar-coded information according to claim 1, wherein the adaptation means is designed to vary the spatial arrangement of the registration means.

3. Arrangement for recognizing bar-coded information according to claim 1, wherein the adaptation means is designed to rotate or to swivel the registration means within an angular range.

4. Arrangement for recognizing bar-coded information according to claim 3, comprising a servomotor designed to move the registration means.

5. Arrangement for recognizing bar-coded information according to claim 1, wherein the registration means is designed to register several elements of an item of bar-coded information simultaneously.

6. Arrangement for recognizing bar-coded information according to claim 5, wherein the registration means comprises a bar-code scanner.

7. Arrangement for recognizing bar-coded information according to claim 6, wherein the registration means comprises a bar-code scanner comprising a coupled-charge device (CCD) read unit.

8. Arrangement for recognizing bar-coded information according to claim 1, wherein the arrangement is designed to register and to evaluate two-dimensionally bar-coded information.

9. Arrangement for recognizing information on a spray can comprising a spray can and with an arrangement for recognizing bar-coded information according to claim 1.

10. Arrangement information recognition on a spray can according to claim 9, wherein the bar-coded information comprises an arrangement of concentric rings.

11. Arrangement information recognition on a spray can according to claim 10, wherein the bar-coded information is an item of two-dimensionally bar-coded information.

12. Process for recognizing information on a spray can with an arrangement for recognizing information on a spray can according to claim 9, comprising:
a) recognizing an item of bar-coded information in a registration zone arranged on the spray can and assessing the validity of the information;
b) changing the registration zone on the spray can if no valid information was recognized in a); and,
c) repeating a) and b) until a valid item of information is recognized or no further change of the registration zone is possible.

13. Process according to claim 12, comprising effecting the change of the registration zone on the spray can by rotating or swiveling the registration means.

14. Medical maintenance appliance, with an arrangement for recognizing information on a spray can according to claim 9, wherein an item of information read out by the arrangement for recognizing an item of bar-coded information is an item of control information for implementing a maintenance procedure for medical appliances.

15. Medical maintenance appliance, with an arrangement for recognizing information on a spray can according to claim 14, wherein an item of information read out by the arrangement for recognizing an item of bar-coded information is an item of control information for implementing a maintenance procedure for dental appliances.

16. Process for maintaining medical appliances, with a medical maintenance appliance according to claim 14, wherein the bar-coded information identifies a treatment agent for medical appliances, and an assigned maintenance sequence is selected on the basis of the identified treatment agent.

17. Process for maintaining medical appliances, with a medical maintenance appliance according to claim 16, wherein the bar-coded information identifies a treatment agent for dental appliances, and an assigned maintenance sequence is selected on the basis of the identified treatment agent.
